(19) United States
(12) Patent Application Publication
(10) Pub. No.: US 2025/0271986 A1
(43) Pub. Date: Aug. 28, 2025

(54) IMAGE DISPLAY METHOD AND APPARATUS

(71) Applicant: Lenovo (Beijing) Limited, Beijing (CN)

(72) Inventors: Wenqiang LIU, Beijing (CN); Liang ZHANG, Beijing (CN)

(21) Appl. No.: 19/059,223

(22) Filed: Feb. 20, 2025

(30) Foreign Application Priority Data
Feb. 28, 2024 (CN) 202410225489.6

(51) Int. Cl. G06F 3/04845; G06F 3/0488

(52) U.S. Cl. CPC G06F 3/04845; G06F 3/0488; G06F 2203/04803

(57) ABSTRACT

An image display method includes displaying a first image in a display region, in response to a first interactive operation for the first image, generating a second image based on the first image, and displaying the second image in the display region. The first interactive operation is used to instruct to shrink the first image. The second image includes a first region and a second region, and the first region is the first image.

### CROSS-REFERENCE TO RELATED APPLICATION

The present disclosure claims priority to Chinese Patent Application No. 202410225489.6, filed on Feb. 28, 2024, the entire content of which is incorporated herein by reference.

### TECHNICAL FIELD

The present disclosure is related to the image technology field and, more particularly, to an image display method and an apparatus.

### BACKGROUND

When an electronic device displays an image and the user of the electronic device performs a specific interactive operation on the displayed image, the electronic device processes the displayed image in response to the interactive operation. For example, when the user performs an interactive operation to enlarge an image, the electronic device increases the size of the displayed image, and when the user performs an operation to shrink the image, the electronic device reduces the size of the displayed image.

In the related technical field, when an electronic device reduces the size of an image, a blank area without image content appears between the display area for displaying the original image and the shrunk image. Take a smartphone as an example, before shrinking the image, the smartphone displays a frame of image in the entire screen. After the image is shrunk in response to the interactive operation, the shrunk image only covers a part of the center of the screen, and other areas of the screen are in a blank state without displaying image content.

Such visual effect is poor and does not satisfy the application needs and impairs user experience.

### SUMMARY

An aspect of the present disclosure provides an image display method. The method includes displaying a first image in a display region, in response to a first interactive operation for the first image, generating a second image based on the first image, and displaying the second image in the display region. The first interactive operation is used to instruct to shrink the first image. The second image includes a first region and a second region, and the first region is the first image.

An aspect of the present disclosure provides an image display apparatus, including a display unit and a generation unit. The display unit is configured to display a first image in a display region. The generation unit is configured to generate a second image based on the first image in response to a first interactive operation for the first image. The first interactive operation is used to instruct to shrink the first image. The display unit is configured to display the second image in the display region. The second image includes a first region and a second region, and the first region is the first image.

An aspect of the present disclosure provides an electronic device, including a screen, one or more processors, and one or more memories. The one or more memories store a computer program that, when executed by the one or more processors, causes the one or more processors to display a first image in a display region, in response to a first interactive operation for the first image, generate a second image based on the first image, and display the second image in the display region. The first interactive operation is used to instruct to shrink the first image. The second image includes a first region and a second region, and the first region is the first image.

### BRIEF DESCRIPTION OF THE DRAWINGS

FIG. 1 illustrates a schematic flowchart of an image display method according to some embodiments of the present disclosure.

FIG. 2 illustrates a schematic diagram of an image display interface according to some embodiments of the present disclosure.

FIG. 3 illustrates a schematic diagram of splicing a first image and a filling image to obtain a second image according to some embodiments of the present disclosure.

FIG. 4 illustrates a schematic diagram showing a positional relationship between a first region and a second region according to some embodiments of the present disclosure.

FIG. 5 illustrates a schematic diagram of a first image and a second image according to some embodiments of the present disclosure.

FIG. 6 illustrates a schematic structural diagram of an image display apparatus according to some embodiments of the present disclosure.

FIG. 7 illustrates a schematic structural diagram of an electronic device according to some embodiments of the present disclosure.

### DETAILED DESCRIPTION OF THE EMBODIMENTS

The technical solutions of embodiments of the present disclosure are described in detail below in conjunction with the accompanying drawings of embodiments of the present disclosure. Obviously, the embodiments described are only some embodiments of the present disclosure, not all embodiments. Based on embodiments of the present disclosure, all other embodiments obtained by those skilled in the art without creative efforts shall fall within the scope of the present disclosure.

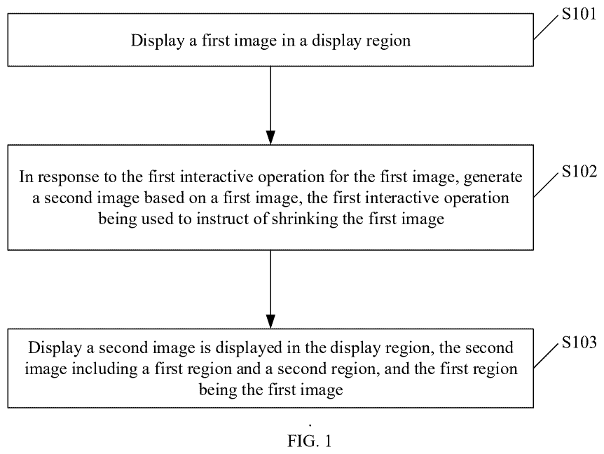

Embodiments of the present disclosure provide an image display method. FIG. 1 illustrates a schematic flowchart of an image display method according to some embodiments of the present disclosure. The method includes the following steps.

At S101, a first image is displayed in a display region.

The image display method of embodiments of the present disclosure can be executed by an electronic device configured to display the first image. To facilitate distinguishment, a main executing object of embodiments of the present disclosure can be referred to as a display device. The display device can include any electronic device, such as a smartphone, tablet, laptop, or desktop computer.

The first image can be obtained by the display device for displaying the first image in various methods. For example, the display device can download the first image from a network, communicate with another electronic device to receive the first image transmitted from another electronic device and obtain the first image captured by a camera assembly of the display device.

The display region can refer to the entire screen region of the display device or a partial region of the screen.

For example, the display device can divide the screen horizontally into two equal regions according to the interactive operation of the user. The left region can be an image display region configured to display an image viewed by the user, and the right region can be another display region configured to display an interface of an application. Thus, the display region of S101 can be the image display on the left.

In step S101, the display device displays the first image in response to a third interactive operation of the user. The third interactive operation is used to instruct the display device to display the first image.

The third interactive operation can include a plurality of manners. For example, after capturing a frame of the image by the camera assembly, the display device can display a thumbnail of the image at the bottom-left corner of the screen. When the user clicks on the thumbnail, the display device can respond to the click operation to display the captured frame of the image. In this scenario, the operation of the user clicking on the thumbnail can be the third interactive operation, and the captured frame of the image can be the first image.

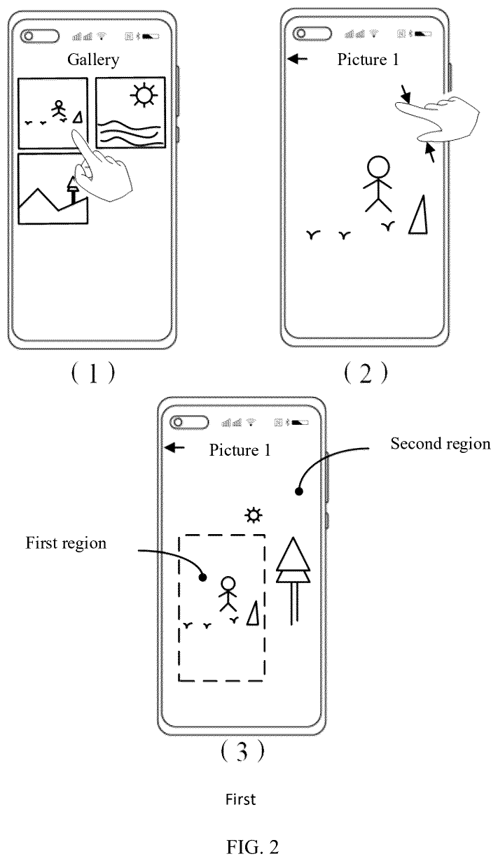

In some other embodiments, the display device can respond to the operation of the user opening an image gallery. The image gallery is displayed as an image viewing interface denoted by (1) of FIG. 2. Thumbnails of a plurality of frames of the image stored in the display device are displayed in the interface. Then, the user clicks on any one thumbnail, e.g., a thumbnail of picture 1 shown in (1) of FIG. 2. The display device responds to the click operation to display the interface shown in (2) of FIG. 2. The picture 1 is displayed in the interface. In this scenario, the operation of the user clicking on the thumbnail of picture 1 can be referred to as the third interactive operation. The region under the term “picture 1” in (2) of FIG. 2 is referred to as the display region of S101. The picture 1 shown in (2) of FIG. 2 is referred to as the first image.

at s102, in response to the first interactive operation for the first image, a second image is generated based on a first image. The first interactive operation is used to instruct shrinking the first image.

The first interactive operation can include various forms. For example, the first interactive operation can include an operation of the user pressing down a button of a control panel of the display device configured to shrink the image, an operation of the user clicking on a control element displayed on the display screen of the display device configured to shrink the first image, a gesture operation of the user performed on the touch screen of the display device to shrink the first image.

Taking (2) of FIG. 2 as an example, the screen of the display device is a touch screen. After the display device displays the first image in the display region, the user can perform a two-finger pinch gesture in the display region. The display device can recognize the operation as the first interactive operation for shrinking the first image.

At s103, a second image is displayed in the display region. The second image includes a first region and a second region. The first region is the first image.

In step S103, the display device can display the generated second image in the display region for displaying the first image. The second image can be divided into the first region and the second region. The shrunk first image can be displayed in the first region.

Taking (3) of FIG. 2 as an example, the display device displays the second image in the display region under the term “picture 1”. The region indicated by a dashed-line rectangle box is the first region. The first image is in the first region. The image content in the second region can be the added image content when the display device generates the second image. The dashed-line rectangle box shown in (3) of FIG. 2 is configured to indicate the first region. In a practical application scenario, the display device may only display the second image without displaying the dashed-line rectangle box shown in (3) of FIG. 2.

The beneficial effects of embodiments of the present disclosure are as follows.

After shrinking the first image based on the interactive operation of the user, the display device can display the second image formed by the first image and the image content of the second region not belonging to the first image in the display region for displaying the un-shrunk first image. Then, the display device can display the shrunk first image according to the interactive operation and fill the blank between the display region and the first region where the shrunk first image is by the image content of the second region. Thus, the visual effect of the display device displaying the shrunk image can be improved.

In the display method of embodiments of the present disclosure, the display device can generate the second image based on the first image in a first generation method or a second generation method.

In the first generation method, the display device can splice the first image and a filling image to generate the second image.

In the second generation method, the display device can send the first image to an intelligent engine and receive the second image generated by the intelligent engine.

In the first generation method, the display device can first select at least one filling image from a plurality of images stored in the display device.

The plurality of images stored in the display device can include at least one of a plurality of images captured by the camera assembly of the display device, a plurality of images downloaded by the display device from the network, or a plurality of images received by the display device from other electronic devices.

The filling image selected by the display device can include an image of the plurality of stored images satisfying condition 1.

In condition 1, the filling image and the first image can be captured by an image collection apparatus at the same moment. The filling image can be captured by a first lens of the image collection apparatus, and the first image can be captured by a second lens of the image collection apparatus. The field of view of the first lens can be greater than the field of view of the second lens.

The image collection apparatus can be the display device displaying the first image or another electronic device different from the display device.

For example, when the image collection apparatus is a smartphone with a plurality of lenses, the first image can be an image captured by a primary lens with a relatively small field of view of the smartphone. The filling image can be an image captured by a wide-angle lens with a relatively large field of view of the smartphone at the same moment.

In some embodiments, to support the display device to generate and display the second image, when the display device includes the plurality of lenses with different fields of view, and the user uses the display device to capture the first image, the display device can capture the first image using a second lens of the plurality of lenses with a relatively small field of view and capture the filling image using a first lens of the plurality of lenses with a relatively large field of view. Thus, when the user performs the first interactive operation on the first image, the second image can be generated and displayed.

In some embodiments, the function of the display device capturing the first image and the filling image at the same moment can be on or off according to the configuration of the user. When the function is on, the display device can capture the first image and the filling image according to the above method. When the function is off, the display device may not capture the filling image at the same moment as capturing the first image. Thus, the function can be prevented from always on to occupy too much storage space of the display device.

The filling image selected by the display device can be an image satisfying condition 2.

In condition 2, the filling image and the first image can be images captured by the same image collection apparatuses at different moments. The similarity of the filling image and the first image can be greater than a predetermined threshold.

In a general capturing scenario, the user can repeatedly adjust the attitude, position, and shooting parameters of the image collection apparatus at the same place, and capture at least one image after each adjustment. A part of the at least one image can be saved. Thus, between the filling image and the first image captured by the same image collection apparatus at different moments, the filling image can include a partial content same as the first image and a partial content not included in the first image.

The different moments of condition 2 can be different moments with a time length interval not longer than a predetermined time length. When the predetermined time length is 5 minutes, the first image can be an image captured by the image collection apparatus at moment TO, and the filling image can be another image captured by the image collection apparatus within 5 minutes after moment TO.

When the filling image satisfying condition 2 is selected, the display device can select several images captured by the same image collection apparatus as the first image at different moments from the plurality of images stored in the display device. Then, the display device can calculate the similarity between each of the selected several images and the first image. Subsequently, the display device can select the image with a similarity greater than the threshold as the filling image. Thus, the filling image can be selected according to this method to reduce the quantity of the images that need the similarity calculation to further reduce the calculation resource consumption and energy consumption for the display device.

The filling image selected by the display device can also be an image satisfying condition 3.

The filling image and the first image can be captured by different image collection apparatuses, and the similarity between the filling image and the first image can be greater than the predetermined threshold.

The predetermined threshold can be set as needed. For example, the predetermined threshold can be set as the similarity between the two images with at least 50% the same.

In some embodiments, the display device can first select an image from the plurality of images stored in the display device satisfying condition 1 as the filling image. If no image satisfies condition 1, the display device can select the image satisfying condition 2 as the filling image. If no image satisfies condition 1 or condition 2, the display device can select an image satisfying condition 3. If no image satisfies condition 1, condition 2, or condition 3, the display device can determine that no filling image exists in the plurality of images stored in the display device.

In some embodiments, after displaying the first image and before responding to the first interactive operation of the user, the display device can first determine whether the plurality of images stored in the display device include a filling image. If yes, the display device can generate and display the second image using the filling image after the user performs the first interactive operation. If not, the display device can continue to display the first image in the display region with the original size after the user performs the first interactive operation and display prompt information simultaneously. The prompt information can be used to prompt the user that the first image cannot be shrunk.

After the filling image is obtained, the display device can splice the first image and the filling image according to the following method.

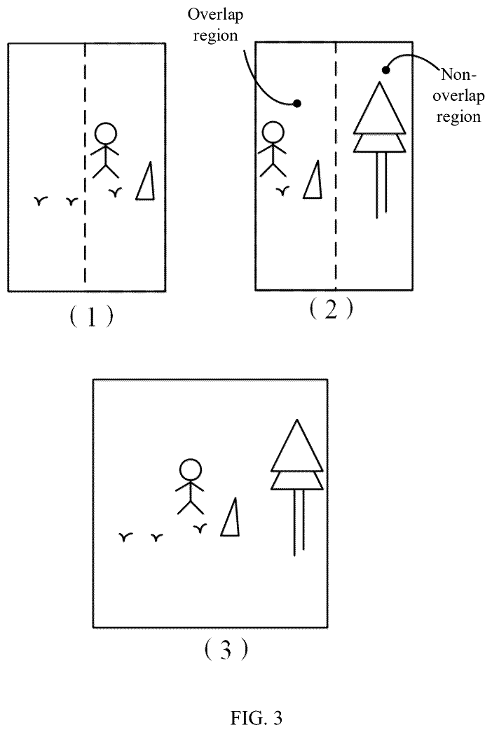

The display device can first determine an overlap region in the filling image that is the same as the first image and a non-overlap region beside the overlap region. In the overlap region, a partial content of the filling image in the overlap region can be the same as the first image or a partial content of the first image. As shown in FIG. 3, (1) of FIG. 3 is the first image, and (2) of FIG. 3 is the filling image determined by the display device. The content in the overlap region on the left side of the dashed line of the filling image is the same as the content on the right side of the dashed line in (1) of FIG. 3. The display device can determine the region on the left side of the dashed line of the filling image in (2) of FIG. 3 as the overlap region and the region on the right side of the dashed line as the non-overlap region of the filling image.

The display device can crop the non-overlap region from the filling image, use the part of the image that is cropped from the filling image as the second region of the second image, and use the first image as the first region of the second image. Then, the display device can splice the first region and the second region to obtain the second image.

When splicing, the position relationship between the first region and the second region can be consistent with the position relationship between the non-overlap region and the overlap region of the filling image.

Taking the second image obtained by splicing in (3) of FIG. 3 as an example, the non-overlap region of the filling image can be on the right side of the overlap region. When the first region is where the first image is and the second region is where the filling image is, the second region can be spliced to the right side of the first region.

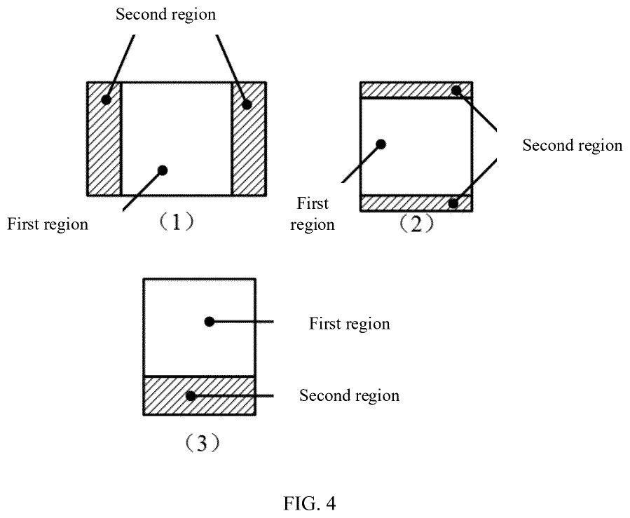

Further, as shown in (1) of FIG. 4, when the overlap region of the filling image is in the middle, and the non-overlap region is above or under the overlap region, the first region of the spliced second image can be in the middle of the second region, and the second region can be above or under the first region.

As shown in (2) of FIG. 4, when the overlap region of the filling image is in the middle, and the non-overlap region is on the left side or right side of the overlap region, the first region of the spliced second image can be in the middle of the second region, and the second region can be on the left side or right side of the first region.

As shown in (3) of FIG. 4, when the overlap region of the filling image is on an upper portion of the filling image, and the non-overlap region is under the overlap region, the first region and the second region of the second image can be arranged in a first direction. In the first direction, the second region can be under the first region.

In some other embodiments, the overlap region can also be under the filling image, and the non-overlap region can be above the overlap region. Then, in the first direction, the second region can be above the first region. Alternatively, the overlap region can be on the left side of the filling image, and the non-overlap region can be on the right side of the overlap region. Then, in the first direction, the second region can be on the right side of the first region. Alternatively, the overlap region can be on the right side of the filling image, and the non-overlap region can be on the left side of the overlap region. Then, in the first direction, the second region can be on the left side of the first region.

In some embodiments, when the display device generates the second image, the display device can determine the size of the second image according to the display region and the size of the first image.

In some embodiments, the display device can determine an aspect ratio of the display ratio and then generate the second image with an aspect ratio consistent with the aspect ratio of the display region. For example, when the aspect ratio of the display region is 16:9, and the display device can generate the second image with the aspect ratio of 16:9.

The advantage of generating the second image with the same aspect ratio as the display region includes that the display device can use the entire display region to display the second image when the second image has an aspect ratio consistent with the aspect ratio of the display region during displaying the second image in the display region. Then, a blank region without image content may not exist in the display area, and the user can have a good visual experience.

In some other embodiments, the display device can determine the aspect ratio of the first image and generate the second image with an aspect ratio consistent with the aspect ratio of the display region. For instance, if the aspect ratio of the first image is 16:9, the display device can generate a second image with an aspect ratio of 16:9.

In other embodiments, the display device can obtain a user-specified aspect ratio according to the interactive operation of the user and generate a second image with the specified aspect ratio.

In a second generation method, the display device can send only the first image to an intelligent engine and receive the second image generated by the intelligent engine, or the display device can select a similar image from the plurality of images stored in the display device with the similarity greater than the threshold. For example, the display device can select an image having the same background as the first image as the similar image and send the first image and the similar image together to the intelligent engine and receive the second image generated by the intelligent engine according to the first image and the similar image.

The threshold for selecting a similar image can be smaller than the predetermined thresholds of condition 2 and condition 3 above.

The intelligent engine can be deployed locally on the display device and operated by hardware resources of the display device. Then, sending the first image to the intelligent engine and receiving the second image generated by the intelligent engine can include that a display program of the display device for displaying an image can transmit the first image to the intelligent engine of the display device. After generating the second image according to the first image, the intelligent engine can transmit the second image to the display program.

The intelligent engine can also be deployed on a cloud server or another electronic device different from the display device. The intelligent engine can be operated by a server or another electronic device. Then, sending the first image to the intelligent engine and receiving the second image generated by the intelligent engine can include that the display device can send the first image to the server or the another electronic device, after generating the second image by the intelligent engine according to the first image, the server or the another electronic device can feedback the second image to the display device.

After the intelligent engine obtains the first image, the first image can be processed to obtain the second image by any one of an image content expansion technology or image content filling technology based on an artificial intelligent algorithm in the image processing technology field. For the principles of the image content expansion technology or image content filling technology based on the artificial intelligent algorithm, references can be made to related references, which are not repeated here.

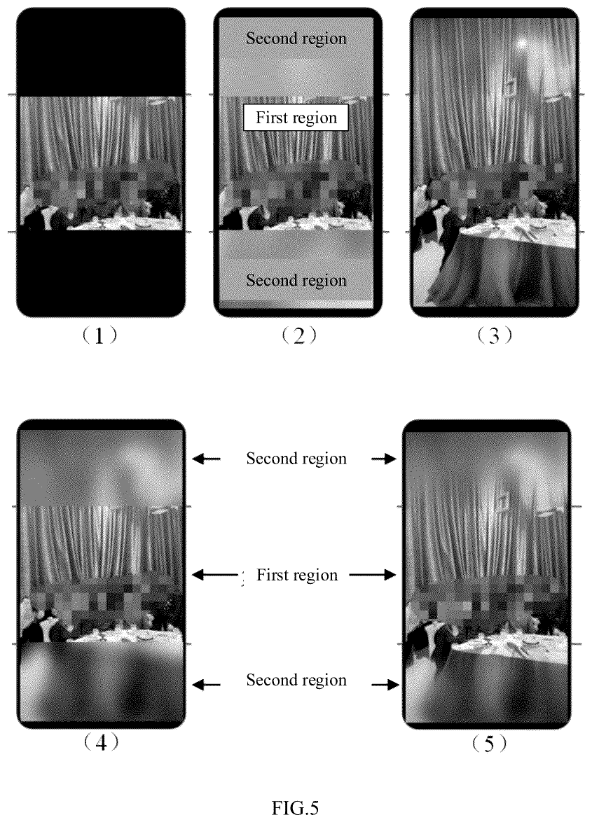

For example, as shown in FIG. 5, the first image of the display device is the image shown in (1) of FIG. 5. After the display device sends the first image to the intelligent engine, the intelligent engine outputs the second image generated according to the first image. The second image can be the image shown in (2) or (3) of FIG. 5.

In the second images shown in (2) and (3) of FIG. 5, the first regions are in the middle of the second image, and the second regions are above and under the first region, respectively. The images in the first regions are the first images, and the images in the second regions are the images generated by the intelligent engine according to the first images.

The intelligent engine can recognize the color of the first image and can generate a corresponding color in the second region according to the color of the first image to obtain the second image shown in (2) of FIG. 5.

In some other embodiments, the intelligent engine can recognize image features of the background portion of the first image and generate an image having the image features in the second region to obtain the second image shown in (3) of FIG. 5. By taking (1) and (3) of FIG. 5 as an example, the intelligent engine can recognize the fabric image feature of the background in (1) of FIG. 5 and generate the fabric image in the second regions above and under according to the image feature to obtain the second image in (3) of FIG. 5.

In some embodiments, to facilitate the user to distinguish the first region and the second region when viewing the second image, when the display device generates the second image, the display device can control the image attribute of the first region to be different from the image attribute of the second region. The image attribute can be any one attribute that can represent the display effect of the image corresponding to the region. For example, the image feature can include any one of sharpness, brightness, or transparency.

After setting different image attributes to the first region and the second region, the image of the first region and the image of the second region can be displayed with different display effects when the display device displays the second image. Thus, the user can intuitively distinguish the first region and the second region of the second image according to the difference in the display effects.

In some embodiments, the image attribute of the first region being different from the image attribute of the second region can include that the image of the first region has a first sharpness, and the image of the second region has a second sharpness. The first sharpness can be larger than the second sharpness. Since the second region has a smaller sharpness, when the display device displays the second image, the image of the second region can have a visual effect of blurring relative to the image in the first region. Then, the user can find that the blurred region of the second image can be the second region, and the un-blurred region can be the first region.

Based on the above, the first sharpness can be the original sharpness of the first image, and the second sharpness can be the sharpness obtained by subtracting a predetermined sharpness difference from the first sharpness. The sharpness difference can be set as needed. For example, the display device can set the sharpness difference according to the user configuration, and the sharpness difference can be greater than the predetermined sharpness threshold.

The sharpness threshold can be a minimal difference needed to cause the images of different sharpnesses to present the blurring effect sensible by the human eyes. That is, for two images with different sharpnesses, if the sharpness difference of the two images is smaller than or equal to the sharpness threshold, the human eyes cannot sense the image blurring effect from the two images, i.e., the sharpnesses of the two images sensed by the human eyes have no difference. Only when the sharpness difference of the two images is greater than the sharpness threshold, can the human eyes sense the image blurring effect from the two images displayed simultaneously.

In another example, the image attribute of the first region being different from the image attribute of the second region can include that the image of the first region has a first transparency, and the image of the second region has a second transparency. The second transparency can be lower than the first transparency.

The first transparency can be the original transparency of the first image, e.g., 100%. The second transparency can be a transparency determined according to the user configuration, e.g., 50% or 30%.

In connection with the above example, the second image generated by the display device is the second image shown in (4) of FIG. 5. The image of the first region has the 100% transparency, and the transparency of the image of the second region can be lower than 100%. Thus, in the second image displayed, the image of the first region can be displayed clearly, and the image of the second region can represent a blurring visual effect.

In some embodiments, image attributes of pixels in the second region can be related to distances between the pixels and boundary pixels of the region where the first image is.

In some embodiments, the display device can set an image attribute range. For the pixels in the second region, from near to far of the distances between the pixels and the boundary pixels of the region (i.e., the first region) where the first image is, the image attributes of the pixels can be set to gradually change from an end of the image attribute range to another end of the image attribute range.

For example, the image attribute can be the transparency. The display device can determine a transparency range greater than or equal to the second transparency and smaller than or equal to the first transparency. The first transparency can be the transparency of the first image, and the second transparency can be any transparency smaller than the first transparency. For example, the first transparency can be 100%, and the second transparency can be 50%.

Based on the transparency range, when the display device generates the second image, the transparencies of the pixels in the second region can be calculated as follows.

In the second region, the transparency of the pixel closest to the boundary pixel of the first region can be the upper limit of the transparency range. That is, the transparency of the pixel closest to the boundary pixel of the first region in the second region can be the first transparency, e.g., 100%.

In the second region, the transparency of the pixel farthest to the boundary pixel of the first region can be the lower limit of the transparency range. That is, the transparency of the pixel farthest to the boundary pixel of the first region can be the second transparency, e.g., 50%.

For other pixels of the second region, from near to far of the distances between the pixels to the boundary pixels of the first region, the transparencies of the pixels can be gradually lowered from the first transparency until the second transparency.

For example, the second image generated according to the above method is the image shown in (5) of FIG. 5.

The method of setting the transparency of the pixels in the second region can be merely an example. In some other embodiments, the distribution of the transparencies of the pixels in the second region can include that when the distance of a pixel of the second region to the boundary pixels of the first region is closer, the transparency of the pixel can be lower. The transparency of the pixel having the closest distance can be the lower limit of the transparency range, and the transparency of the pixel having the farthest distance can be the upper limit of the transparency range.

In some embodiments, the transparency can be replaced by another image attribute representing the display effect of the image, e.g., sharpness and brightness, not limited to transparency.

In some embodiments, when the display device generates the second image in response to the first interactive operation, the display device can recognize the interaction parameter of the first interactive operation. Based on the interaction parameter, whether to generate the second image can be determined. That is, the method of the display device generating the second image can include that, in response to the first interactive operation for the first image, if the interaction parameter of the first interactive operation satisfies a parameter condition, the display device generates the second image based on the first image, and if the interaction parameter of the first interactive operation does not satisfy the parameter condition, the display device does not generate the second image and continues to display the first image in the display region.

The interaction parameter can represent the operation amplitude of the interactive operation.

The interaction parameter satisfying the parameter condition can include that the interaction parameter is greater than or equal to the predetermined first interaction parameter threshold, the interaction parameter is smaller than the second interaction parameter threshold, or the interaction parameter is within the predetermined interaction parameter range.

The interaction parameter threshold and the interaction parameter range can be set by the display device according to the user configuration or by the manufacturer, which is not limited.

With different forms of the first interactive operation, the interaction parameters can be different.

For example, the first interactive operation can be an operation of the user continuing to press down the button on the control panel of the display device configured to shrink the first image, or the user continuing to click on the control element displayed on the display screen of the display device configured to shrink the first image, the interaction parameter can be the time length for pressing down the button or clicking on the control element.

When the first interactive operation is the two-finger pinch gesture performed by the user on the touch screen of the display device, the interaction parameter can be the amplitude of the two-finger pinch gesture.

In some embodiments, after the display device displays the second image, the second image in the display area can be restored to the first image according to the following method, including displaying the first image in the display region in response to the second interactive operation for the second image. The second interactive operation can be used to instruct to enlarge the second image.

The second interactive operation can include a plurality of forms. For example, the second interactive operation can be an operation of the user pressing down the button on the control panel of the display device configured to enlarge the second image, an operation of the user clicking on the control element displayed on the display screen of the display device configured to enlarge the second image or an operation of the user performing a gesture operation for enlarging the second image on the touch screen of the display device.

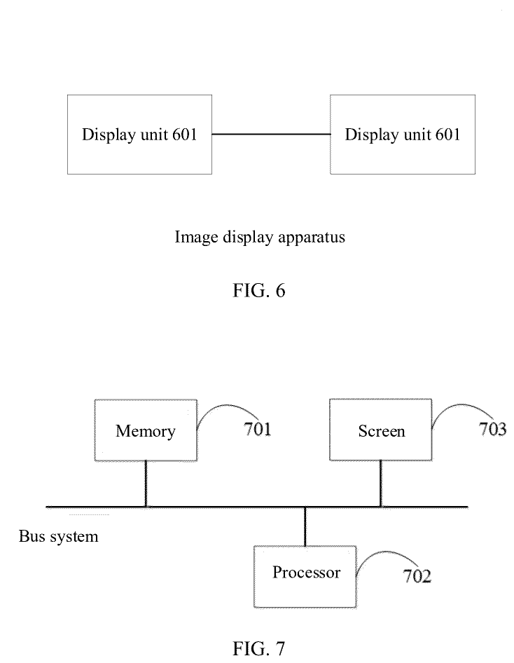

Embodiments of the present disclosure can further provide an image display apparatus. FIG. 6 illustrates a schematic structural diagram of the image display apparatus according to some embodiments of the present disclosure. The apparatus includes a display unit 601 and a generation unit 602.

The display unit 601 can be configured to display the first image in the display region.

The generation unit 602 can be configured to generate the second image in response to the first interactive operation for the first image. The first interactive operation is used to instruct to shrink the first image.

The display unit 601 can be configured to display the second image.

The second image can include the first region and the second region. The first region can be the first image.

In some embodiments, when the generation unit 602 generates the second image based on the first image, the generation unit 602 can be configured to splice the first image and the filling image to generate the second image or send the first image to the intelligent engine and receive the second image generated by the intelligent engine.

In some embodiments, the filling image and the first image can be captured by the same image collection apparatus at the same moment. The filling image can be captured by the first lens of the image collection apparatus. The first image can be captured by the second lens of the image collection apparatus. The field of view of the first lens can be greater than the field of view of the second lens.

In some other embodiments, the filling image and the first image can be captured by the same image collection apparatus at different moments, and the similarity of the filling image and the first image can be greater than the predetermined threshold.

In some other embodiments, the filling image and the first image can be captured by different image collection apparatuses, and the similarity of the filling image and the first image can be greater than the predetermined threshold.

In some embodiments, the first region can be in the middle of the second region, or the first region and the second region can be arranged in the first direction.

In some embodiments, the aspect ratio of the second image can be consistent with the aspect ratio of the display region.

In some embodiments, the image attribute of the first region can be different from the image attribute of the second region. The image attribute can represent the display effect of the image corresponding to the region.

In some embodiments, the image attributes of the pixels in the second region can be related to the distances of the pixels to the boundary pixels of the region where the first image is.

In some embodiments, when generating the second image in response to the first interactive operation for the first image, the generation unit 602 can be configured to generate the second image based on the first image if the interaction parameter of the first interactive operation satisfies the parameter condition, in response to the first interactive operation for the first image. The interaction parameter can represent the operation amplitude of the interactive operation.

In some embodiments, after displaying the second image in the display region, the display unit 601 can be further configured to display the second image in the display region in response to the second interactive operation for the second image. The second interactive operation can be used to instruct to enlarge the second image.

For the operation principles of the image display apparatus of embodiments of the present disclosure, reference can be made to the related steps of the image display method of embodiments of the present disclosure, which are not repeated.

Embodiments of the present disclosure can further provide an electronic device. FIG. 7 illustrates a schematic structural diagram of the electronic device according to some embodiments of the present disclosure. The electronic device includes a memory 701, a processor 702, and a screen 703.

The memory 701 can be used to store a computer program.

The processor 702 can be configured to execute the computer program stored in the memory 701 to display the image in the display region of the screen 703 according to the image display method of embodiments of the present disclosure.

Embodiments of the present disclosure further provide a non-transitory computer-readable storage medium. The non-transitory computer-readable storage medium can be used to store the computer program that, when executed by the processor, causes the processor to implement the image display method above.

Embodiments of the present disclosure are described in a progressive manner. Each embodiment focuses on differences from other embodiments. The same or similar parts between embodiments of the present disclosure can refer to each other.

To facilitate description, when the above system or apparatus is described, the system and apparatus can be functionally divided into various modules or units for description. Of course, when the present disclosure is implemented, the functions of the units can be implemented in one or more pieces of software and/or hardware.

According to the description of embodiments of the present disclosure, those skilled in the art can clearly know that the present disclosure can be implemented by software plus a necessary hardware platform. Based on this understanding, the essence or the part contributing to the related technology of the technical solution of the present disclosure can be partially embodied by a software product. The computer software product can be stored in the storage medium, e.g., ROM/RAM, magnetic discs, optical discs, etc., and include several instructions used to cause a computer device (e.g., a personal computer, server, or network device) to perform embodiments of the present disclosure or the method described in some embodiments of the present disclosure.

In the specification, relationship terms “first,” “second,” “third,” and “fourth” can be merely used to distinguish one entity or operation from another entity or operation and may not necessarily require or imply that any actual relationship or sequence exists between the entities or operations. The terms “include,” “comprise,” or any other variations are intended to cover non-exclusive inclusion, such that a process, method, article, or device that includes a series of elements includes not only those elements, but also other elements not expressly listed, or elements inherent to the process, method, article or device. When there is no further limitation, the element defined by the statement “comprise a . . . ” does not exclude the presence of additional identical elements in the process, method, article, or device that includes the element.

The above are only some embodiments of the present disclosure. For those of ordinary skill in the art, several improvements and modifications can be made without departing from the principles of the present disclosure. These improvements and modifications are within the scope of the present disclosure.

What is claimed is:

1. An image display method comprising:
displaying a first image in a display region;
in response to a first interactive operation for the first image, generating a second image based on the first image, the first interactive operation being used to instruct to shrink the first image; and
displaying the second image in the display region;
wherein the second image includes a first region and a second region, and the first region is the first image.

2. The method according to claim 1, wherein generating the second image based on the first image includes:
splicing the first image and a filling image to generate the second image; or
sending the first image to an intelligent engine and receiving the second image generated by the intelligent engine.

3. The method according to claim 2, wherein:
the filling image and the first image are captured by a same image collection apparatus at a same moment, the filling image is captured by a first lens of the image collection apparatus, and the first image is captured by a second lens of the image collection apparatus, and a field of view of the first lens is greater than a field of view of the second lens;
the filling image and the first image are captured by the same image collection apparatus at different moments, and a similarity between the filling image and the first image is greater than a predetermined threshold; or
the filling image and the first image are captured by different image collection apparatuses, and the similarity between the filling image and the first image is greater than the predetermined threshold.

4. The method according to claim 1, wherein:
the first region is in the middle of the second region; or
the first region and the second region are arranged in a first direction.

5. The method according to claim 4, wherein an aspect ratio of the second image is consistent with an aspect ratio of the display region.

6. The method according to claim 1, wherein:
an image attribute of the first region is different from an image attribute of the second region; and
the image attribute represents a display effect of an image corresponding to a region.

7. The method according to claim 6, wherein image attributes of pixels in the second region are related to distances between the pixels and boundary pixels of the region where the first image is.

8. The method according to claim 1, wherein generating the second image based on the first image in response to the first interactive operation for the first image includes:
in response to the first interactive operation for the first image, and an interaction parameter of the first interactive operation satisfying a parameter condition, generating the second image based on the first image;
wherein the interaction parameter represents an operation amplitude of the interactive operation.

9. The method according to claim 1, further comprising, after displaying the second image in the display region:
in response to a second interactive operation for a second image, displaying the first image in the display region;
wherein the second interactive operation is used to instruct to enlarge the second image.

10. An image display apparatus, comprising:
a display unit, configured to display a first image in a display region;
a generation unit, configured to generate a second image based on the first image in response to a first interactive operation for the first image, the first interactive operation being used to instruct to shrink the first image; and
the display unit, configured to display the second image in the display region;
wherein the second image includes a first region and a second region, and the first region is the first image.

11. The apparatus according to claim 10, wherein the generation unit is further configured to splice the first image and a filling image to generate the second image; or
send the first image to an intelligent engine and receive the second image generated by the intelligent engine.

12. An electronic device, comprising:
a screen;
one or more processors; and
one or more memories storing a computer program that, when executed by the one or more processors, causes the one or more processors to:
display a first image in a display region;
in response to a first interactive operation for the first image, generate a second image based on the first image, the first interactive operation being used to instruct to shrink the first image; and
display the second image in the display region;
wherein the second image includes a first region and a second region, and the first region is the first image.

13. The device according to claim 12, wherein the one or more processors are further configured to:
splice the first image and a filling image to generate the second image; or
send the first image to an intelligent engine and receive the second image generated by the intelligent engine.

14. The device according to claim 13, wherein:
the filling image and the first image are captured by a same image collection apparatus at a same moment, the filling image is captured by a first lens of the image collection apparatus, and the first image is captured by a second lens of the image collection apparatus, and a field of view of the first lens is greater than a field of view of the second lens;
the filling image and the first image are captured by the same image collection apparatus at different moments, and a similarity between the filling image and the first image is greater than a predetermined threshold; or
the filling image and the first image are captured by different image collection apparatuses, and the similarity between the filling image and the first image is greater than the predetermined threshold.

15. The device according to claim 12, wherein:
the first region is in the middle of the second region; or
the first region and the second region are arranged in a first direction.

16. The device according to claim 15, wherein an aspect ratio of the second image is consistent with an aspect ratio of the display region.

17. The device according to claim 12, wherein:
an image attribute of the first region is different from an image attribute of the second region; and
the image attribute represents a display effect of an image corresponding to a region.

18. The device according to claim 17, wherein image attributes of pixels in the second region are related to distances between the pixels and boundary pixels of the region where the first image is.

19. The device according to claim 12, wherein the one or more processors are further configured to:
in response to the first interactive operation for the first image, and an interaction parameter of the first interactive operation satisfy a parameter condition, generating the second image based on the first image;
wherein the interaction parameter represents an operation amplitude of the interactive operation.

20. The device according to claim 12, wherein after displaying the second image in the display region, the one or more processors are further configured to:
in response to a second interactive operation for a second image, display the first image in the display region;
wherein the second interactive operation is used to instruct to enlarge the second image.
